(19) United States
(12) Patent Application Publication
(10) Pub. No.: US 2014/0003202 A1
(43) Pub. Date: Jan. 2, 2014

(54) Alarm Clock With Earpiece

(71) Applicant: Salvatore Randazzo, Hartford, CT (US)

(72) Inventor: Salvatore Randazzo, Hartford, CT (US)

(21) Appl. No.: 13/539,899

(22) Filed: Jul. 2, 2012

(51) Int. Cl. G04F 1/00

(52) U.S. Cl. 368/89

(57) ABSTRACT

An alarm clock system that includes: a clock transmitter; and at least one earpiece for use within an ear of an user, wherein said at least one earpiece receives signals from the clock transmitter and said at least one earpiece includes an outer mold that secures a speaker within a canal of the earpiece and a flush outer surface, where the flush outer surface remains flush in an ear opening of the user. In one particular embodiment, the at least one earpiece emits a sound into the ear of the user upon receipt of a signal from the clock transmitter. In another exemplary embodiment, the at least one earpiece emits vibration upon receipt of a signal from the clock transmitter. The clock transmitter transmits at least one of a RF signal and a Bluetooth signal to the at least one earpiece.

### BACKGROUND OF THE INVENTION

1. Field of Invention

The present invention relates to an alarm clock that includes an earpiece to enable the transmission of an alerting alarm to the earpiece inserted in a user's ear.

2. Description of Related Art

Alarm clocks are widely used by individuals to awake or to alert them to a preset time. Normally the alarm clock is used to awake an individual who may be asleep in order that they may awaken at a predetermined time. Furthermore clocks are used to alert an individual merely of a particular time of the day. Alarm clocks normally emit a loud piercing sound so that an individual may be alerted. Occasionally the sound may be buzzing, ringing or music may be utilized to wake the individual. Consequently these devices are very useful for individuals who have normal hearing or who are not hearing impaired. However the sound levels necessary to awake a person with hearing impairment are sometimes greater than which can be emitted by a normal alarm clock. Further, one individual may require to awaken at a different time as opposed to the other individual, where two individuals in a bedroom share an alarm. These drawbacks to the traditional alarm clock may be addressed through the use of earpieces.

Earpiece alarm clocks have been developed in the prior art that utilize an earpiece inserted into a user's ear as an alarm receiver therefore ensuring that the individual hears the alarm and provides a means to alert an individual who may have a hearing impairment of an alarm alert. Many of the earpiece alarms of the prior art extend from an ear or may be uncomfortable to wear while sleeping. One example of a personal alarm alert system is identified in U.S. Patent Application No. 2011/0235469. Another example of an alarm clock and an earpiece system for awaking is disclosed in U.S. Patent Application No. 2010/0195447. In these prior art examples the earpieces are bulky and are not inserted flush into the ear. Consequently the systems of the prior art may be uncomfortable for the user during sleep.

Therefore the object of the present invention is to provide an alarm waking system that utilizes an earpiece used in conjunction with an alarm transmitter. The earpiece is molded in a fashion that it suitable to insert into the hearing canal of the individual and to fit flush therein.

### SUMMARY OF THE INVENTION

The present invention relates to an alarm clock system comprising: a clock transmitter; and at least one earpiece for use within an ear of an user, wherein said at least one earpiece receives signals from the clock transmitter and said at least one earpiece includes an outer mold that secures a speaker within a canal of the earpiece and a flush outer surface, where the flush outer surface remains flush in an ear opening of the user. In one particular embodiment, the at least one earpiece emits a sound into the ear of the user upon receipt of a signal from the clock transmitter. In another exemplary embodiment, the at least one earpiece emits vibration upon receipt of a signal from the clock transmitter. The clock transmitter transmits at least one of a RF signal and a Bluetooth signal to the at least one earpiece.

### BRIEF DESCRIPTION OF DRAWINGS

FIG. 1 depicts a transmitter clock used in conjunction with the present invention.

FIG. 2 depicts an earpiece used with the alarm alert system in accordance with the present invention.

FIG. 3 depicts placement of the earpiece into the ear of a user.

### DETAILED DESCRIPTION

The present invention relates to an alarm alert system that utilizes an earpiece along with a transmitter with a transmission signal from the transmitter to the earpiece to emit an audible sound within the earpiece or alternatively for the earpiece to vibrate therefore alerting the user that the alarm has been triggered.

The design of the present invention utilizes a flush fitting earpiece that is comfortable for the user to wear during sleep. This comfortable fit ensures the comfort of the user. The alarm may be set with controls provided on the transmitter and upon arriving at the predetermined time the transmitter transmits a signal using a radio frequency or Bluetooth technology to the earpiece.

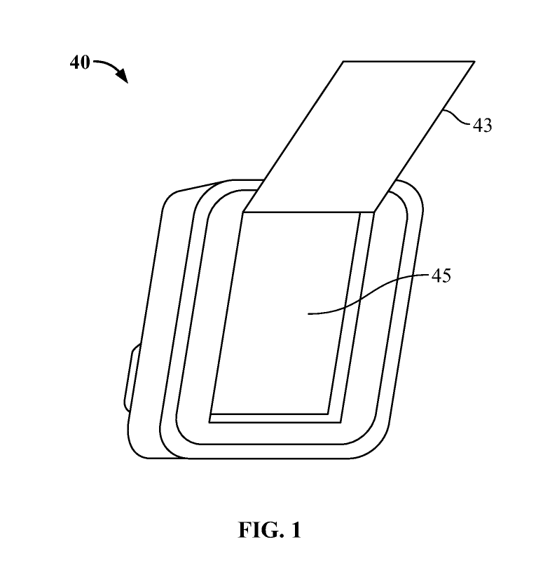

With respect to FIG. 1, a transmitter 40 in accordance to the present invention is depicted. The transmitter 40 includes an opening or folding door 43 that opens to provide access to controls within the transmitter 40. The transmitter 40 is battery operated and includes a battery, not shown, and a display 45. The display 45 includes various control buttons or mechanism to control the functionality of the transmitter 40 as used in conjunction with an earpiece. Appropriate circuitry is provided within the transmitter 40 to enable a clock or timer and for the transmission of a RF signal or Bluetooth technology to an earpiece.

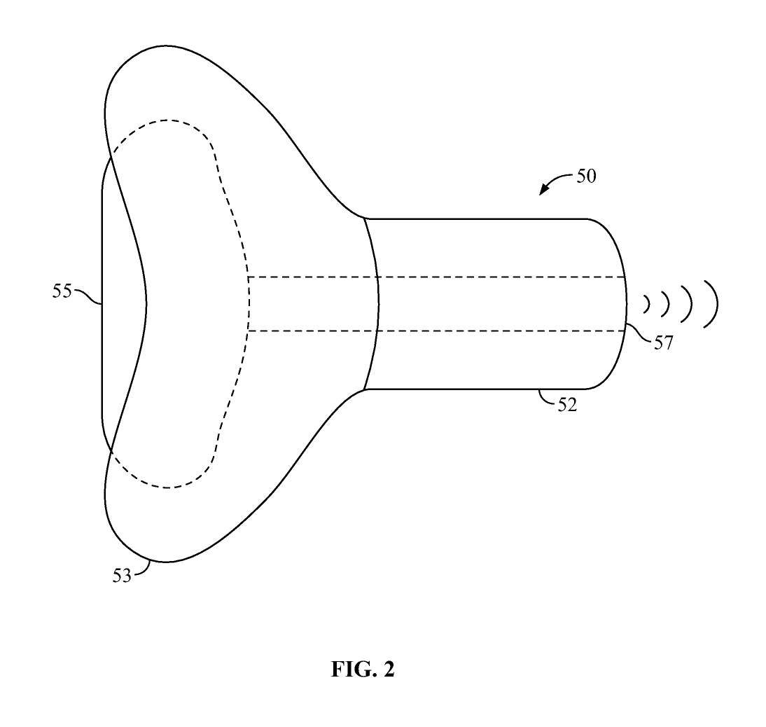

FIG. 2 depicts an earpiece 50 in accordance with the present invention. The earpiece 50 includes an outer mold 53 that secures a speaker 57 within a canal 52 of the earpiece 50. A flush outer surface 55 is provided and remains flush in the ear opening of the user. The earpiece 50 emits an audible alert to a speaker 57 directly into the user's ear. This audible alert provides a means to awake the user of the earpiece 50. The alert is provided upon transmission of the signal from the transmitter 40 as depicted in FIG. 1. Because the earpiece 50 has the flush surface 55 it provides a comfortable earpiece for the user to wear while sleeping.

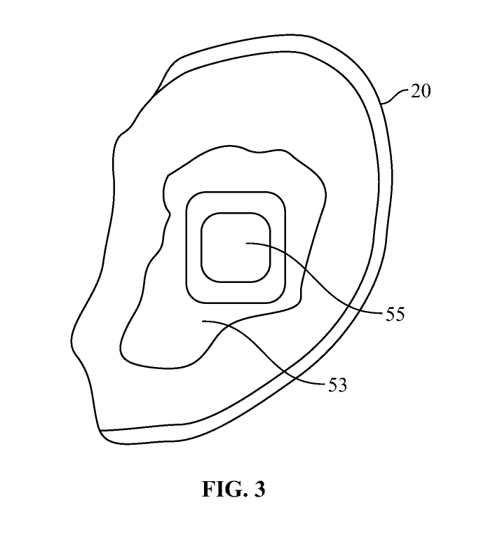

In reference to FIG. 3, the earpiece 50 is shown inserted into an ear 20. As shown, the flush outer surface 55 and outer mold 53 remain flush to the skin of the ear. The earpiece 50 therefore easily remains in place and secure in the ear of the user.

The transmitter 40 includes controls along within the interior, not shown, for setting and controlling the clock utilized with the transmitter 40. The folding door 43 is lockable as to prevent tampering with the alarm once set by the user. Use of the present invention creates a means for the hearing impaired to be awakened in an effective manner with a comfortable earpiece for use with the transmitter 40. The present invention may also be used by individuals who may have a spouse sharing the bedroom and therefore allows an individual to be awakened without disturbing the sleeping spouse. The transmissions of the signal from the transmitter 40 may be in the form of an RF signal or utilizing Bluetooth signaling techniques to transmit the signal and to initialize the audible alarm of the earpiece 50. Further the earpiece 50 will be equipped with the means to vibrate as an alternative means to awaken he user. Therefore the earpiece is quite effective in awakening the user and providing an effective means for alerting the user of the predetermined alarm time. The instant invention has been shown and described in what it considers to be the most practical and preferred embodiments. It is recognized, however, that departures may be made there from within the scope of the invention and that obvious modifications will occur to a person skilled in the art.

What is claimed is:

1. An alarm clock system comprising:
a. a clock transmitter; and
b. at least one earpiece for use within an ear of an user, wherein said at least one earpiece receives signals from the clock transmitter and said at least one earpiece includes an outer mold that secures a speaker within a canal of the earpiece and a flush outer surface, where the flush outer surface remains flush in an ear opening of the user.

2. The alarm clock system according to claim 1, where the at least one earpiece emits a sound into the ear of the user upon receipt of a signal from the clock transmitter.

3. The alarm clock system according to claim 1, where the at least one earpiece emits vibration upon receipt of a signal from the clock transmitter.

4. The alarm clock system according to claim 1, where the clock transmitter transmits at least one of a RF signal and a Bluetooth signal to the at least one earpiece.

5. The alarm clock system according to claim 1, where the clock transmitter includes a display and a battery provides power to the clock transmitter.

6. The alarm clock system according to claim 1, where said clock transmitter includes a folding door to access controls.
